(19) United States
(12) Patent Application Publication
(10) Pub. No.: US 2026/0154918 A1
(43) Pub. Date: Jun. 4, 2026

(54) SYSTEMS AND METHODS FOR REAL-TIME MULTI-USER VIDEO STREAMING FROM USER DEVICES FOR ON-DEMAND INTERACTIVE METAVERSE SESSIONS

(71) Applicant: VITAVERSE INC., Los Angeles, CA (US)

(72) Inventor: Heather Ines Shaw, Los Angeles, CA (US)

(73) Assignee: VITAVERSE INC., Los Angeles, CA (US)

(21) Appl. No.: 19/460,024

(22) Filed: Jan. 26, 2026

Related U.S. Application Data
(63) Continuation of application No. 18/352,706, filed on Jul. 14, 2023, now abandoned.
(60) Provisional application No. 63/389,263, filed on Jul. 14, 2022.
(60) Provisional application No. 63/389,268, filed on Jul. 14, 2022.

(51) Int. Cl. G06T 19/00; H04N 9/75; H04N 21/254; H04N 21/81

(52) U.S. Cl. CPC G06T 19/006; H04N 9/75; H04N 21/2541; H04N 21/8146

(57) ABSTRACT

Systems and methods may generate real-time virtual venues having real-world images of users. The images of users may be extracted from video streams using artificial intelligence (AI) image recognition models and combined with virtual venues to generate video streams having virtual venues with real-world images of users in real-time. The video streams may be produced by a user's mobile device and transmitted to a server. A user's display device may receive a pixel streaming solution in real time that depicts the user in a virtual environment. The systems and methods may permit users to attend virtual events in a virtual environment, such as virtual concerts held at virtual events. Ticketing and other system management may be performed by microservices for efficient and shared management of the users and virtual venues.

### CROSS-REFERENCE TO RELATED APPLICATIONS

This application is a continuation of U.S. Non-Provisional application Ser. No. 18/352,706; filed Jul. 14, 2023, which claims the benefit of priority of U.S. Provisional Application No. 63/389,268, filed Jul. 14, 2022, and U.S. Provisional Application No. 63/389263, filed on Jul. 14, 2022, which are each incorporated by reference in their entireties herein for all purposes.

### BACKGROUND

The metaverse is a concept in which users can be connected through social networks in a three-dimensional (“3D”) virtual world. To participate in the metaverse, a user is typically required to wear head-mounted gear that covers the head to fully immerse the user in the 3D virtual world. However, such head-mounted gear may be prohibitively expensive for many users and is cumbersome to wear. These and other issues may prevent widespread adoption of the metaverse.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment that embeds real-time streaming videos of users into 3D virtual venues.

FIG. 2 illustrates an example of a real-time video streaming subsystem that uses AI-based image processing to extract images of users that appear in real-world video streams and integrates the extracted images into 3D virtual venues.

FIG. 3 illustrates an example of a pixel streaming subsystem for presenting 3D virtual venues to users in real-time.

FIG. 4 illustrates a schematic diagram of an example of a microservices architecture that facilitates user participation in 3D virtual venues.

FIG. 5 illustrates an example of a method of embedding real-time streaming videos of users into 3D virtual venues.

FIG. 6 illustrates an example method of a mobile device for enabling access to a virtual venue for a user.

FIG. 7 illustrates an example method of a display device for displaying the user in the virtual venue.

FIG. 8 illustrates an example of a virtual venue using the streaming services described herein.

FIG. 9 illustrates another example of a 3D venue.

FIG. 10 illustrates an example of a computer system that may implement the devices illustrated in FIG. 1.

### DETAILED DESCRIPTION OF THE INVENTION

The disclosure relates to systems and methods of extracting real-world images of users in real-time videos through artificial intelligence (AI) image recognition models, combining the extracted real-world images into virtual venues, pixel streaming the combination, and microservices for shared management of the users and virtual venues.

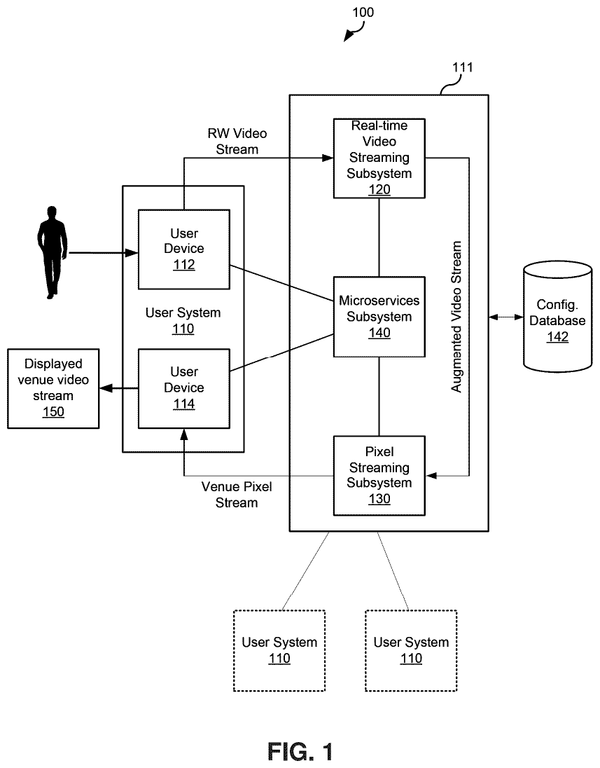

FIG. 1 illustrates an example of a system environment 100 that embeds real-time streaming videos of users into 3D virtual venues for the users to participate in virtual events such as concerts in real-time, without using virtual avatars and without the need for dedicated virtual reality devices. The system environment 100 may include user systems 110, a real-time video streaming subsystem 120, a pixel streaming subsystem 130, a microservices subsystem 140, and/or other components.

A user system 110 may be operable by a user to generate a real-world video stream of the user, transmit the real-world video stream to the multi-user virtual venue system 111 (“venue system 111”) and receive a venue pixel stream that includes virtual venues combined with real-world video of the user and/or other users. The term “real-world video” refers to video capture of an environment in the real world including actual users. The term “virtual venue” refers to computer-generated multi-media that depict an environment.

Each user system 110 may include a plurality of user devices. For example, as illustrated, the user system 110 may include a first user device 112 and a second user device 114, which may be separate devices (such as housed in individual housings) or may be housed within a single device. Only a single user system 110 is shown in detail in FIG. 1 for clarity. The user device 112 and the user device 114 may each provide respective functions of the user system 110.

For example, the user device 112 may generate the real-world video stream and transmit the real-world video stream to the real-time video streaming subsystem 120 for processing. The real-world video stream may include video capture of a user moving, as an example. The user device 112 may be a smartphone, a tablet device, a laptop device, a game console, and/or other device that includes or is coupled to an image capture device such as a camera.

The user device 114 may receive and display the venue video stream from the pixel streaming subsystem 130. For example, the user device 114 may be a smartphone, a tablet device, a laptop device, a game console, and/or other device that includes or is coupled to a display device that displays the venue video stream. It should be noted that the user device 112 and the user device 114 may be separate devices (which may be individually operated by the user). In other examples, the user device 112 and the user device 114 are integrated within a single device such as within a single housing.

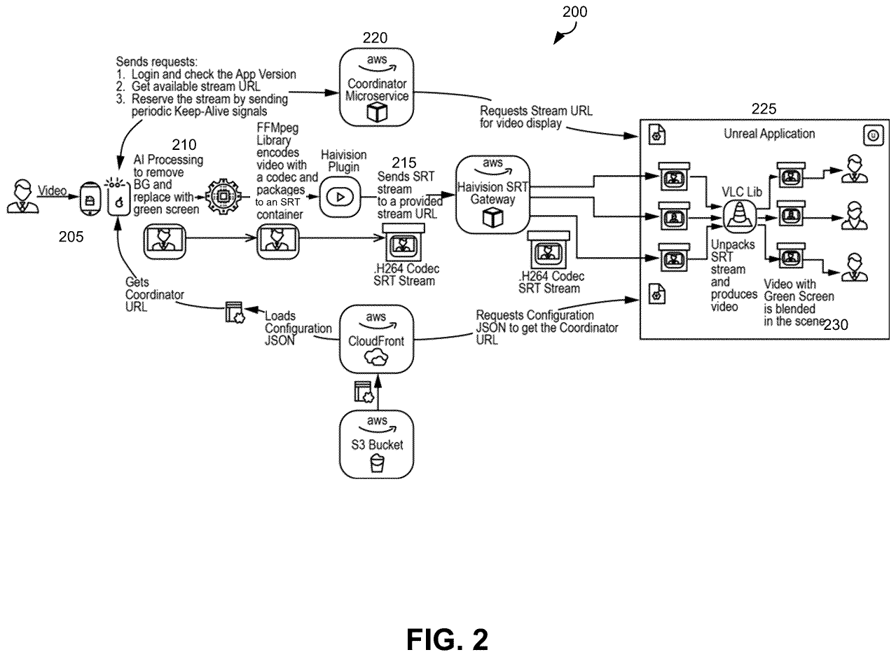

The real-time video streaming subsystem 120 may receive the real-world video stream from the user device 112, and virtually insert the user from the real-world video stream into an augmented video stream that includes the user depicted in a virtual venue. For example, the real-time video streaming subsystem 120 may identify, via artificial intelligence (AI) image models, portions of the real-world video stream that correspond to some or all of the body of the user. The real-time video streaming subsystem 120 may mask the portions in the real-world video stream that correspond to the user and apply a background color to remaining portions of the real-world video stream that do not correspond to the user. The real-time video streaming subsystem 120 may then replace the background color with a virtual venue to generate an augmented video stream. An example of the real-time video streaming subsystem 120 will be described with reference to FIG. 2.

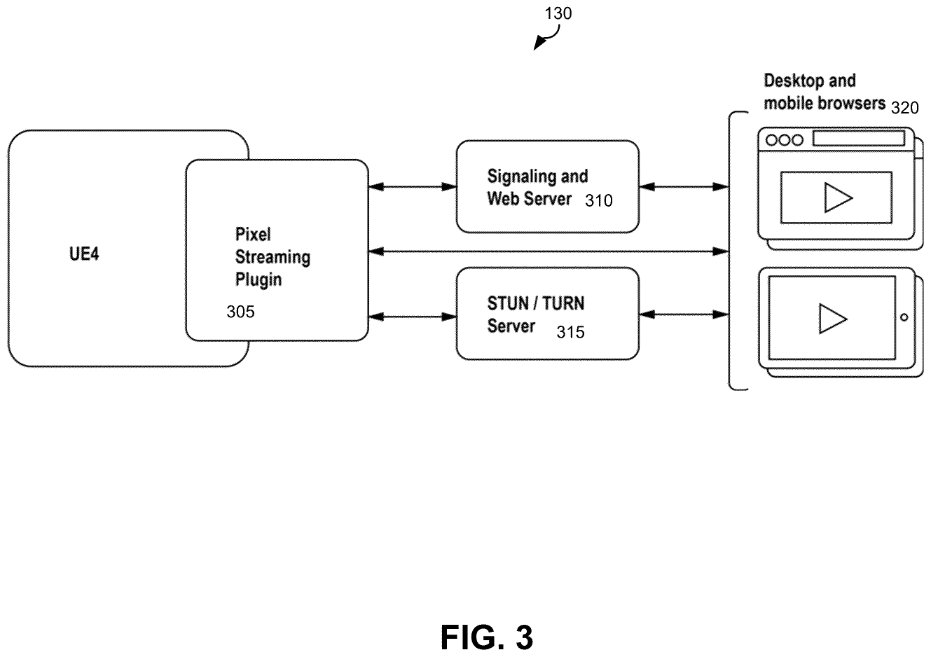

The pixel streaming subsystem 130 may access the augmented video stream from the real-time video streaming subsystem 120 and generate a venue pixel stream from the augmented video stream. The pixel streaming subsystem 130 may transmit the venue pixel stream to the user device 114, which may display the venue pixel stream 150. Thus, the user will be able to see themselves or an avatar of themselves in the virtual environment in the displayed venue video stream 150. Motions made by the user in the real world may be replicated and displayed in real time in the virtual environment while being visible to the user in the displayed venue video stream 150. All of this may be accomplished without expensive and bulky VR or AR equipment, which is not accessible to many users and may also impede forms of expression of a user when the user is forced to wear such cumbersome VR or AR equipment. An example of the pixel streaming subsystem 130 will be described with reference to FIG. 3.

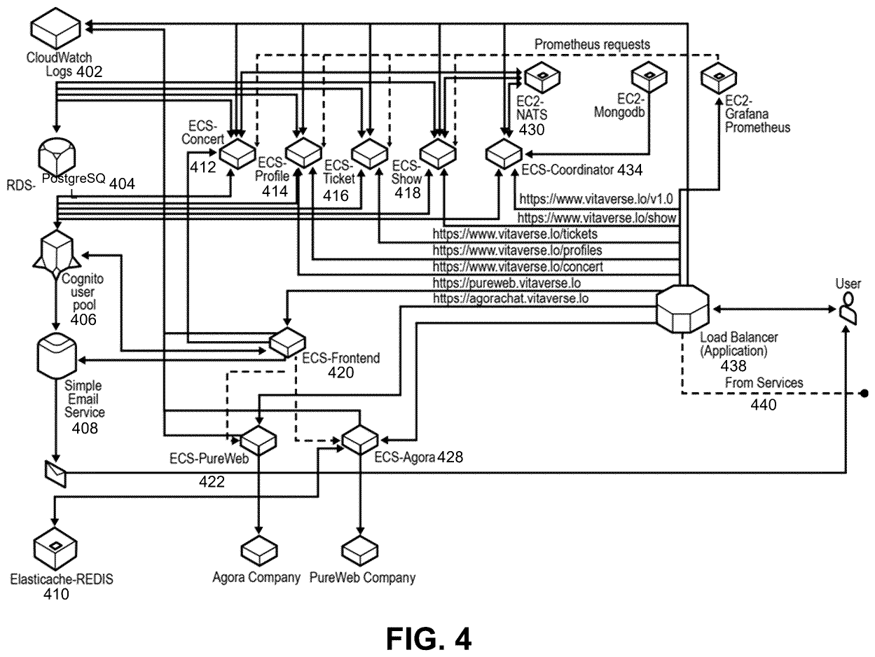

The microservices subsystem 140 may include individual services that each handle respective functionality of the venue system 111. The individual services may operate on a shared computational architecture, such as computational hardware and configurations stored in the configuration database 142. An example of the microservices subsystem 140 will be described with reference to FIG. 4.

The configuration database 142 may store user accounts and configurations for the user accounts. For example, the configuration database 142 may store a username or alias that is displayed for the user, access control information that indicates virtual venues for which the user is permitted to access, user history information, and/or other information for each user.

According to some examples, the microservices subsystem 140 may provide one or more of the following services.

### General Assembly (GA) Ticket Purchase Facilitation

The microservices subsystem 140 may support GA ticket purchases to users who desire to participate in the virtual environment. The GA ticket may provide access into the venue where ticket holders can explore the virtual environment world, live chat with friends, engage with specialized interactivities, and show up on the platforms/pods for all to see in the virtual environment.

### Ticket Upsells

The microservices subsystem 140 may also provide opportunities for users to purchase additional features, functionality, or access in the virtual environment through ticket upselling.

### Featured Audience Dance VIP

The microservices subsystem 140 may also provide bridging functionality to allow the user to be featured in the virtual environment. For example, the user or audience generally can choose to spend a little more money on a larger version of themselves, dancing larger than life on their platform/pod for 10-15 seconds and making them a feature on the final live stream.

### Celebrity and Artist Hangouts

The microservices subsystem 140 may also allow for Top Level VIP packages that offer virtual meet and greets inside a user's platform/pod or VIP Area with the artist playing that night in the virtual environment, or your other favorite celebrities or sports players! Hang out together in the venue, chat face to face, and snap a selfie with your new best mate!

### Special Celebration Skins

The microservices subsystem 140 may also allow users to choose from a library of skins for their area to further customize their special event, such as theme party skins and special birthday options.

### Non-Ticket Revenue Generation

The microservices subsystem 140 may also enable functionality of the user to participate in the virtual environment through different means than typical revenue generating features. Below are some examples.

### Multi-Currency Platform

The microservices subsystem 140 may support a currency platform that enables a multitude of different payment methods. Virtual wallets on the frontend are designed to accept and use multiple types of currency including crypto and fiat. Also, artists may be able to integrate their own coin systems within the virtual environment. The microservices subsystem 140 may also facilitate a virtual real estate, which represents estimated virtual platforms/pods that are minted and auctioned at the launch event, providing a community fund and investment. Users may be offered an opportunity to bid and purchase virtual spaces to be granted exclusive access or functionality that are present in the event.

As another example, the microservices subsystem 140 may facilitate a merchandise area designed to include VIP Auction platforms/pods for NFT sales and auctions. In some examples, the intended use of blockchain or other distributed ledger may be used to authenticate digital assets from music, ticketing and/or streaming content.

### Digital Real Estate Auction

As alluded to above, the microservices subsystem 140 may be configured to provide minted platforms/pods that will be designed to be available for auction premiering at a launch event. The audience will be able to purchase real estate in the digital realm. Subscribers can own and share their own platform/pod with friends.

### Non-Fungible Token (NFT) Merchandise

As another example, the microservices subsystem 140 may provide access for artists to sell original NFT art and merchandise sold in a virtual store or at a digital gallery auction.

### Play to Earn Model

The microservices subsystem 140 may also generate a system for allowing users to earn digital currency through activity or other means besides spending currency. For example, as users accumulate experiences, they may get closer and closer to earning special recognition in the form of badges or other signifiers (e.g. participation in 10 digital events award VIP status), unlocking rewards like early access to buy tickets or discounted ticket rates. The microservices subsystem 140 may post a series of goals for a user to achieve throughout an event, such as visiting certain virtual rooms, performing various activities in the venue, engaging in certain social events or talking with other virtual users, each of which may earn the user some amount of digital currency that can be spent on items in the virtual environment. The microservices subsystem 140 may cause an acknowledgement to be displayed in the pixel stream, so that the user can see the achievement or reward reached in the display device 114 of the user.

Referring again to FIG. 1, the configuration database 142 may also store information relating to a virtual venue. The virtual venue information may include a three-dimensional virtual rendering of a virtual venue. In some examples, a virtual venue may have a parent-child relationship with another virtual venue. The parent-child relationships may include a 1-to-1 relationship, a 1-to-many relationship, or a many-to-1 relationship. Furthermore, each virtual venue may be part of multiple parent-child relationships. In this example, a virtual venue may be a parent to a virtual venue and a child to another virtual venue.

In some examples, a venue system 111 may interact with another venue system, not shown, in a sort of parent-child relationship. That is, multiple joint ventures may be configured to branch out from under a larger umbrella of virtual venues. These different venues may be curated partnerships for artists and brands and will remain open at all times, perpetually hosting both live and re-run performances. Connecting between these larger venues, node-based venues will hold lower profile events for up-and-coming artists, as well as independent user to create their own shows. Subscribers and ticketed users may also be able to travel freely amongst these separate venues.

As an example, the venue system 111 may be connected to another venue system, not shown, that opens the user's options to many other venues, some of which may be open at all times.

An example operation will now be described for illustration. In operation, a user may open an application on the user device 112. For example, the user device 112 may be a smartphone or tablet device and the application may be a “mobile app.” The application may logon to the venue system 111 via the microservices subsystem 140. Based on the logon, the microservices subsystem 140 may identify the user and corresponding access privilege to one or more virtual venues. The user's access may be based on what the user has purchased in the event and may provide more privileged access to various places in the virtual venue compared to what other users have who did not pay for such access. For example, the user may be associated with a ticket to enter a virtual concert. The virtual concert or other virtual event may take place in the virtual venue. The microservices subsystem 140 may establish a URL for the user to participate in the virtual concert. The user may use the user device 114 to visit the URL to participate the virtual concert. For example, the user device 114 may be a laptop device that includes a web browser application.

The user device 112 may transmit the real-world video stream to the real-time video streaming subsystem 120, which may generate an augmented video stream. The augmented video stream includes real-world video of the user within the virtual venue to which the user has access. The real-time video streaming subsystem 120 may provide the augmented video stream to the pixel streaming subsystem 130. The pixel stream subsystem 130 may generate a venue pixel stream, which is a pixel stream version of the augmented video stream. The pixel stream subsystem 130 may transmit the venue pixel stream to the user device 114 via the established URL. The user device 114 may display the venue pixel stream within a browser of the user device 114.

Having described a high-level overview of the system 100, examples of more detailed computational processes of the system components will now be described.

For example, FIG. 2 illustrates an example illustration 200 of a real-time video streaming subsystem 120 that uses AI-based image processing to extract images of users that appear in real-world video streams and integrates the extracted images into 3D virtual venues.

At 205, the user uses a mobile app to start video streaming. The video streaming requires no AR or VR equipment. In this way, the user can engage with the virtual venue without any device touching the user, providing for a more comfortable and less cumbersome user experience. The mobile app may direct a camera or other image capture device from the user's mobile device to record the user, for example. The streaming video may then be uploaded and streamed to the real-time video streaming subsystem 120.

At 210, the video stream may be processed by the real-time video streaming subsystem 120 through an AI Image Processing Model to mask the human silhouette and replace the background with a chroma key. For example, the background surrounding the user may be replaced with a green color. Then, the green color may be substituted to a transparent section in the video, thereby capturing only the human video images. To accomplish this, in some examples, DeepLab v3 Model may be used for human segmentation. Alternatively, FritzAI may be used as an example, as well as other models that vary in quality and speed.

Next, at 215, this modified stream is packed by the real-time video streaming subsystem 120 into a secure reliable transport (SRT) container and sent to an SRT streaming server. An example is the Haivision SRT Gateway. The SRT streaming server endpoint may be defined by the SRT Coordinator Microservice 220.

According to some examples, at the same time, a subsystem application 225 of the real-time video streaming subsystem 120, such as an Unreal Application, handles service to virtual shows and ticketing. The subsystem application 225 loads the user video stream and displays it at the specified location in the virtual world. This subsystem application 225 provides information about the venue schedule and the venue configuration, such as what kind of pods and how many should be placed in a virtual venue, and what kinds of places should be offered. The ticket service of the subsystem application 225 provides information on the bought ticket, such as what pod a user has access to and in what virtual place, as well as ticket time reflecting both time for interactive opportunities and non-interactive opportunities. Generally, the ticket in this context defines to which venue the streaming will happen and prevents entry without a previously bought ticket. In some examples, the final place is defined by the show service, because a user can change the pod and place in real time using a frontend web application such as on the user's device.

At 230, a special shader that may be supported or offered by the subsystem application 225 is applied to the user video stream to convert the green background color transparent, and then replace with the background image of the virtual venue. For example, the subsystem application 225 may uniformly convert to transparent all instances of the same green shade in the captured video data.

FIG. 3 illustrates an example of a pixel streaming subsystem 130 for presenting 3D virtual venues to users in real-time. In some examples, the user starts the web application, such as an application run by Unreal Engine 4, and requests the Pixel Streaming (PS) web application 305. Without launching the PS application 305, the user may be able to chat and view the virtual experience without engaging directly in the virtual venue.

Using the PS application 305, the user may connect to a desktop or mobile browser 320 to browse and select the show that the user wants to engage in. The browser 320 may communication with a signaling and web server 310 to find available virtual venues for the user to select. In addition, a STUN/TURN server 315, that is, a server that implements Session Traversal Utilities for NAT (STUN) and Traversal Using Relays around NAT (TURN) protocols, may also communicate between the PS application 305 and the browser 320. The user may then select a pod associated with that show and buys the interactive ticket. When the show starts, the user may enter the show and view it in the browser. A QR code may be displayed on screen, and the user uses their mobile device to scan the QR code, install and launch the mobile application. The user may then enter the web application, where he can setup the “avatar” image and start the video streaming. Once logged into the virtual venue and streaming his avatar using the techniques described in FIG. 2, for example, the user uses the web app to switch the pods, communicate with audio and text, meet other people, invite friends, and overall engage in the virtual venue with all access he has authorized by his ticket.

Still referring to FIG. 3, in some examples the PS subsystem 130 connects to the PS Coordinator microservice and requests a free PS machine. The PS Coordinator provides the free PS machine or spins up another remote machine to start a new remote session. The UE app running on the remote PS machine starts WebRTC image and sound streaming. These streams are processed through the Signaling Server 310 and accepted by the user PS web application 320. Additional data from the user to the UE app and back is sent the same way.

FIG. 4 illustrates a schematic diagram of an example of a microservices architecture that may implement the microservices subsystem 140 and that facilitates user participation in 3D virtual venues. This architecture may be implemented as a backend application that may be run on a user's device. In other examples, the architecture may be implemented in a backend server. The architecture described herein may provide the facilitation of the user interacting with different components of the virtual venue, such as the frontend ticket services and the interface to the show or main event in the virtual venue. For example, this application may connect to other services 440 through a load balancer application 438. The load balancer application 438 also handles user interactions. These functions may be processed by AWS Fargate, as one example of an engine platform.

Various modules that provide external communications and functionality are included in the microservices subsystem 140. For example, the load balancer application 438 may connect to the electronic commercial solution (ECS) Agora 428, which handles voice and text chat services. As another example, the Cognito user pool module 406 may provide user authentication and management functionality and may connect to the ECS Frontend module 420 that provides a frontend interface for users. In addition, an email service module 408 may be included to handle email functionality to users. The ECS PureWeb module 422 may provide real time streaming functionality.

Interactions from the load balancer application 438 include modules that handle in-house microservices. For example, the ECS Profile module 414 handles user profile operations and login functions. The ECS Show module 418 handles show schedules, associated metadata and configuration data associated with the shows. The ECS Ticket module 416 handles user ticket operations, such as providing or limiting access based on the ticket, and delivering the tickets to users. The ECS Concert module 412 handles the virtual state of a concert in the show, and metadata and user places associated with the concert. The Logs module 402, which may be implemented by CloudWatch or other similar platforms for example, may stores user and microservice logs in connection with all operations. The ECS Coordinator module 434 may include both an SRT Coordinate module and a PS Coordinator module. The SRT Coordinator module may handle SRT machines and user streams, consistent with those described in FIG. 2, while the PS Coordinator module may handle PS machines and PS to web communications, consistent with those described in FIG. 3.

Supporting the various microservices modules may be various in-house auxiliary services. For example, the Elastic Compute Cloud (EC2) NATS module 430 may provide secure communications between the microservices modules, such as module 412, 414, 416, 418 and 434. The PostgreSQL module 404 may provide a common database for all of the microservices modules to access, for any common or shared information between the modules. The Elasticache REDIS module 410 may provide a fast runtime database to the ECS Agora module 428.

It is apparent that FIG. 4 also shows example interactions and various connections between the described modules according to the many arrows, and are just some of the ways in which the various modules interrelate to one another. Furthermore, while FIG. 4 illustrates various modules using several specific web services platforms, such as EC2 and ECS, these modules may be implemented using other web services platforms and servers known to those with skill in the art, and examples herein are not so limited.

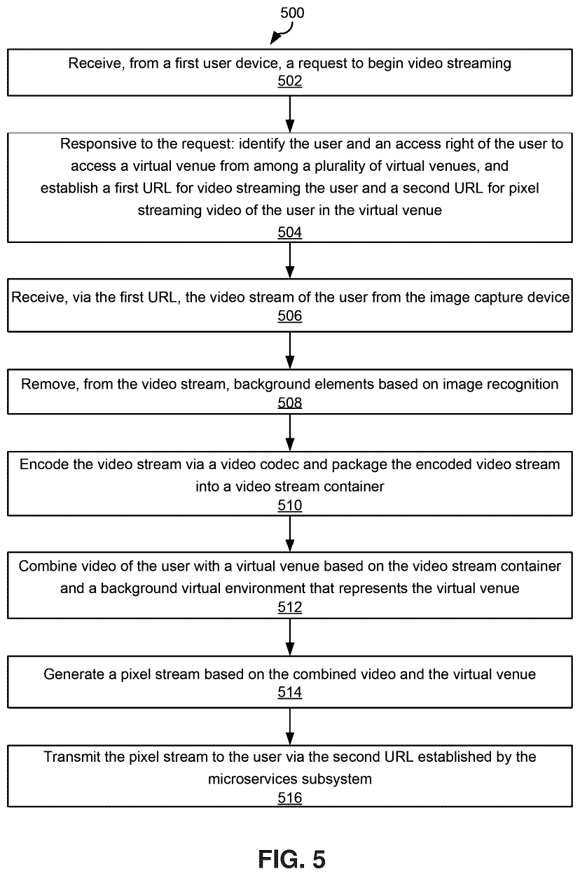

FIG. 5 illustrates an example of a method 500 of embedding real-time streaming videos of users into 3D virtual venues.

At 502, the method 500 may include receiving, from a first user device, a request to begin video streaming.

Responsive to the request, at 504, the method 500 may include identifying the user and an access right of the user to access a virtual venue from among a plurality of virtual venues, and establishing a first URL for video streaming the user and a second URL for pixel streaming video of the user in the virtual venue.

At 506, the method 500 may include receiving, via the first URL, the video stream of the user from the image capture device.

At 508, the method 500 may include removing, from the video stream, background elements based on image recognition.

At 510, the method 500 may include encoding the video stream via a video codec and package the encoded video stream into a video stream container.

At 512, the method 500 may include combining video of the user with the virtual venue based on the video stream container and a background virtual environment that represents the virtual venue.

At 514, the method 500 may include generating a pixel stream based on the combined video and the virtual venue.

At 516, the method 500 may include transmitting the pixel stream to the user via the second URL established by the microservices subsystem.

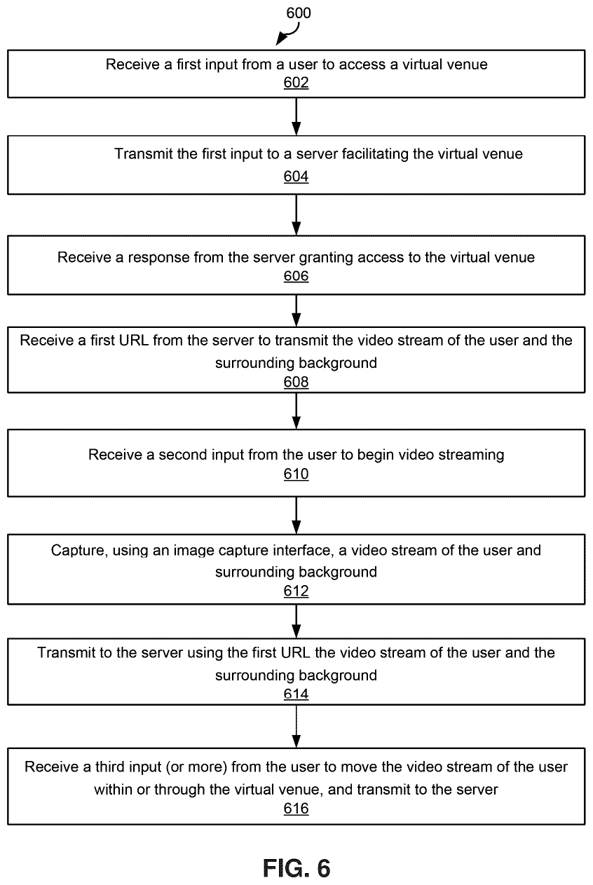

FIG. 6 illustrates an example method of a mobile device for enabling access to a virtual venue for a user. An example of the mobile device described in FIG. 6 may be the user device 112 in FIG. 1 that provides video streaming that is sent to the system 111. At 602, a user interface of the mobile device may receive a first input from the user to access a virtual venue. The virtual venue may be any of the types of virtual venues described herein, including being one of a number of virtual venues to choose from available by a remote server. At 604, the mobile device may transmit the first input to the server through a wireless interface. At 606, the mobile device may receive, through the wireless interface, a response from the server granting access to the virtual venue. The first input by the user may include login credentials and other authentication features to verify that the user has permitted access to the particular virtual venue. This may also include ticketing information and a level of access that indicates different privileges, consistent with descriptions above.

At 608, the mobile device may receive from the server a first URL to transmit back to the server a video stream of the user and surrounding background. At 610, the mobile device may receive a second input from the user to begin video streaming. At 612, the mobile device may use an image capture interface to capture the video stream of the user and any surrounding background. For example, the mobile device may be propped up or otherwise stably positioned to direct the video camera at the user, so that the user can be recorded. The image capture interface of the mobile device may be able to determine a distance of the user relative to the surrounding background, so that the user can be isolated for digital processing later. At 614, the wireless interface of the mobile device may transmit to the server using the first URL the video stream of the user, including the surrounding background. The streaming to the server may occur in real time, such that the user's actions and movements will be continuously captured.

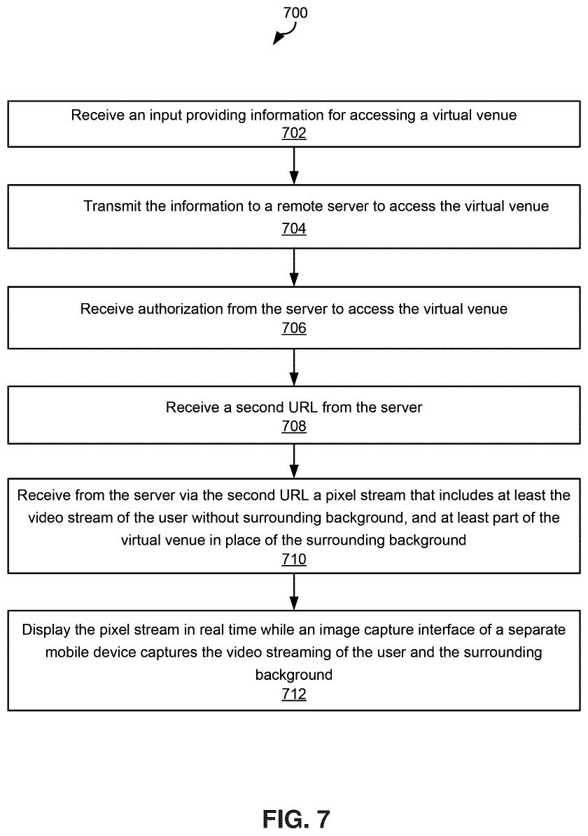

Through a display terminal of a second user device, the user may be able to see himself or herself in the virtual venue at this point. FIG. 7 describes more details of the second user device that displays the user and the virtual venue. Now, the mobile device can receive more inputs to allow the user to interact in the virtual venue. Besides capturing movement, at 616, the user interface of the mobile device may receive a third or more inputs from the user to move the avatar of the user, as represented by the video stream, through the virtual venue. These inputs may be transmitted to the server to cause the server to change the virtual venue accordingly or have the user's avatar, as expressed by the video streaming of the user, to move through the virtual venue accordingly. Examples of various programming modules, and their various functions, that facilitate these inputs may be described in FIG. 4.

FIG. 7 illustrates an example method of a display device for displaying the user in the virtual venue. An example of the display device described in FIG. 7 may be the user device 114 in FIG. 1 that receives the venue pixel stream from the system 111 and displays the venue video stream 150. The display device could be a smart television in the user's home, or a computer controlled by the user, as some examples. In some cases, the display device may be configured with a special module or computer program to access the server of the virtual venue and to interface with the user's mobile device when required. In some cases, the display device may be configured to launch a web browser to open a URL that accesses information about the virtual venue on a server. At 702, the display device may receive an input providing information for accessing a virtual venue. The information may include a URL to access a website. The information may also include a password or login information provided by the user to indicate which virtual venue the user is accessing on the website. For example, the user may enter matching login information at a website interface shown on the display device that is the same as or is consistent with the login information in the user's mobile device. In other cases, the mobile device may sync with the display device via some near-field communication protocol to provide the access information to the display device. At 704, an interface shown on the display device may transmit this information to the remote server facilitating the virtual venue to access the virtual venue. The interface of the display device may include a wired or wireless interface, such as an interface connected to the user's wifi network. In other cases, the interface may be a website user interface that connects to the virtual venue using the user's wifi network At 706, the display device may receive authorization from the server to access the virtual venue.

At 708, in some cases, the display device may receive a second URL from the server. At 710, the display device may receive from the server, via the second URL, a pixel stream that includes at least the video stream of the user without the surrounding background. Replacing the surrounding background would be various parts of the virtual venue, so that the user appears to be placed within the virtual venue. In some cases, the displayed pixel stream showing the user in the virtual venue may be accessed directly through the website interface that the user logged into on the display device. In these cases, the second URL may be sent to the website on the display device, and the live streaming of the virtual venue may be received by the display device and displayed directly in the website interface on the display device.

At 712, the display device may display the pixel stream in real time while the image capture interface of the separate mobile device captures the video streaming of the user and the surrounding background. The display device may continue to display the user moving in the virtual venue, along with any changes of where the user is moving within the virtual venue.

In addition, in some examples, the display device may also display any modifications to the user, such as any skins or accessories that the user has purchased, as the user moves through the virtual venue. For example, the skins may place new clothes on the user while the user is moving in the virtual venue.

In some cases, the display device may also provide additional functionality for the user to switch between different displays within the virtual venue. An interface on the display device, for example using the website interface, may provide options for the user to select between different views in the virtual venue. For example, one view in the virtual venue may show the user dancing with friends who are also streaming and accessing the virtual venue. The user may select a second view that changes from one pod to another in the virtual venue. Each pod may show different groups of users interacting in the virtual venue. The user may select a third view that pans or floats around the virtual venue like how a drone may fly above an area.

Together with the mobile device 112 and the descriptions of FIG. 6, these two devices may represent an overall user system 110 that the user can easily access within the comforts of his or her own home. In this way, the user can enjoy lively interactions with other people in an exciting virtual environment without expensive or cumbersome equipment within their own home.

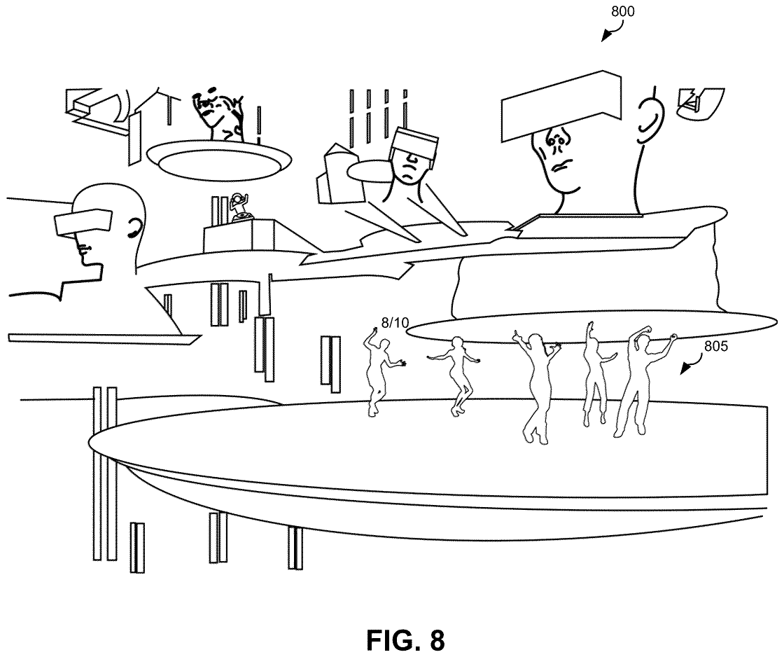

FIG. 8 illustrates an example of a virtual venue 800 using the streaming services described herein. Avatars 805 are placed in a virtual setting to appear on a platform amidst various graphics displayed in a background. The avatars 805 may be streaming video captures of the users themselves. The streaming video captures may be obtained from a user's device in the comfort of their own homes, for example. Techniques for placing the users in the virtual venue may be consistent with the descriptions of FIGS. 2 and 3. Using the same or a separate device, the full virtual venue 800 as shown in FIG. 8 may be displayed on a digital screen or display in the user's home, enabling the user to see themselves in the virtual venue along with other people.

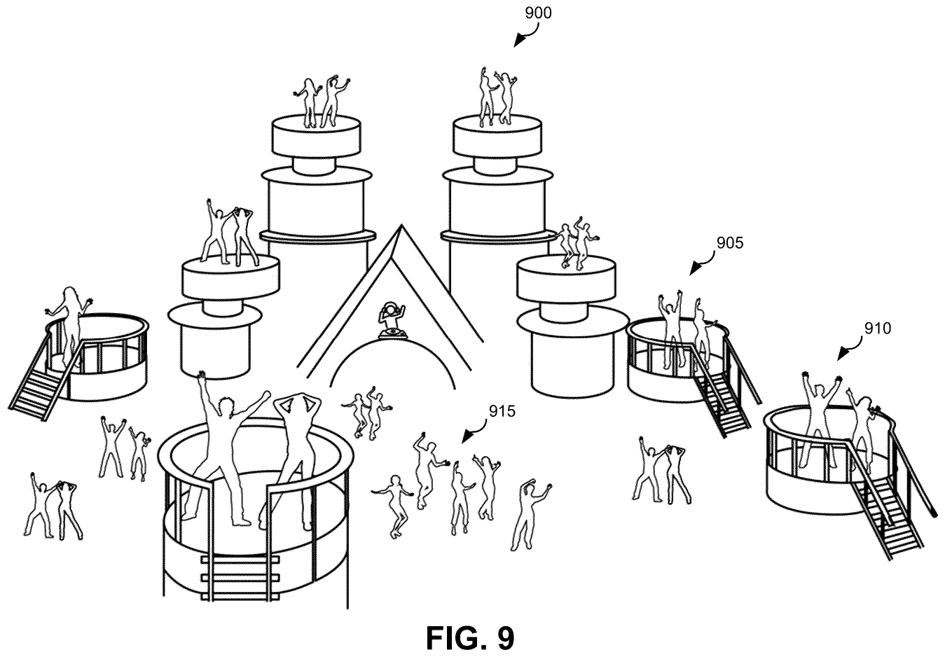

FIG. 9 illustrates another example of a 3D venue 900. In this illustration, various avatars 905, 910 and 915 (as well as others as shown, not referenced), are placed in different sections, referred to as pods, throughout the whole virtual venue. Some shows using the streaming platform as described herein may specify a number of these different pods to allow users to have different experiences in the virtual show. The tickets that the users purchase may provide them different access according to these pods, as one example. In some cases, certain pods may cost more, and may provide more visibility or prestige in the virtual show. Placing the users according to their ticket designations may be consistent with the descriptions of FIGS. 1-7.

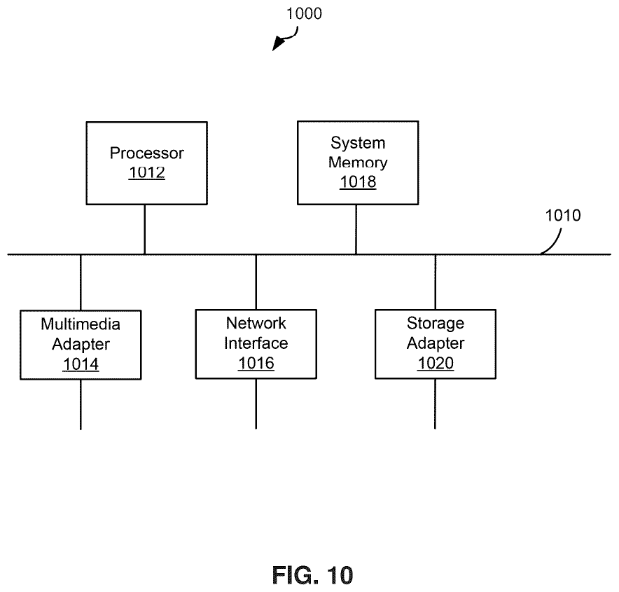

FIG. 10 illustrates an example of a computer system 1000 that may implement the devices illustrated in FIG. 1. The computer system 1000 may be part of or include the system environment 100 to perform the functions and features described herein. For example, various ones of the devices of components of system environment 100 (such as the venue system 111, the real-time video streaming subsystem 120, the pixel streaming subsystem 130, and/or the microservices subsystem 140) may be implemented based on some or all of the computer system 1000.

The computer system 1000 may include, among other things, an interconnect 1010, a processor 1012, a multimedia adapter 1014, a network interface 1016, a system memory 1018, and a storage adapter 1020.

The interconnect 1010 may interconnect various subsystems, elements, and/or components of the computer system 1000. As shown, the interconnect 1010 may be an abstraction that may represent any one or more separate physical buses, point-to-point connections, or both, connected by appropriate bridges, adapters, or controllers. In some examples, the interconnect 1010 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 1010 may allow data communication between the processor 1012 and system memory 1018, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 1012 may control operations of the computer system 1000. In some examples, the processor 1012 may do so by executing instructions such as software or firmware stored in system memory 1018 or other data via the storage adapter 1020. In some examples, the processor 1012 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 1014 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 1016 may provide the computer system 1000 with an ability to communicate with a variety of remote devices over a network. The network interface 1016 may include, for example, an Ethernet adapter, a Fibre Channel adapter, and/or other wired- or wireless-enabled adapter. The network interface 816 may provide a direct or indirect connection from one network element to another, and facilitate communication and between various network elements.

The storage adapter 1020 may connect to a standard computer readable medium for storage and/or retrieval of information, such as a fixed disk drive (internal or external).

Other devices, components, elements, or subsystems (not illustrated) may be connected in a similar manner to the interconnect 1010 or via a network. The devices and subsystems can be interconnected in different ways from that shown in FIG. 10. Instructions to implement various examples and implementations described herein may be stored in computer-readable storage media such as one or more of system memory 1018 or other storage. Instructions to implement the present disclosure may also be received via one or more interfaces and stored in memory. The operating system provided on computer system 1000 may be MS-DOS®, MS-WINDOWS®, OS/2®, OS X®, IOS®, ANDROID®, UNIX®, Linux®, or another operating system.

In some aspects, the techniques described herein relate to a system, including: a microservices subsystem configured to: receive, from a first user device, a request to begin video streaming; and responsive to the request: identify a user and an access right of the user to access a virtual venue from among a plurality of virtual venues, and establish a first URL for video streaming the user and a second URL for pixel streaming video of the user in the virtual venue; a video processing subsystem configured to: receive, via the first URL, the video stream of the user from an image capture device; remove, from the video stream, background elements based on image recognition; encode the video stream via a video codec and package the encoded video stream into a video stream container; and combine video of the user with the virtual venue based on the video stream container and a background virtual environment that represents the virtual venue; and a pixel streaming subsystem configured to: generate a pixel stream based on the combined video and the virtual venue; and transmit the pixel stream to the user via the second URL established by the microservices subsystem.

In some aspects, the techniques described herein relate to a system, wherein the video processing subsystem is further configured to replace background elements of the video stream with a chroma key; wherein to combine the video of the user with the virtual venue, the video processing subsystem is further configured to replace the chroma key with the background virtual environment.

In some aspects, the techniques described herein relate to a system, wherein to generate the pixel stream, the pixel streaming subsystem is further configured to combine video of other users with the virtual venue and display the other users next to the combined video of the user in the virtual venue.

In some aspects, the techniques described herein relate to a system, wherein the pixel streaming subsystem is further configured to place the combined video of the user into privileged access areas in the virtual venue based on a level of the access right of the user.

In some aspects, the techniques described herein relate to a system, wherein the first user device is a mobile device of the user.

In some aspects, the techniques described herein relate to a system, wherein the image capture device is the mobile device of the user.

In some aspects, the techniques described herein relate to a system, wherein to transmit the pixel stream to the user via the second URL established by the microservices subsystem, the microservices subsystem is further configured to transmit the pixel stream to a display device of the user that is separate from the first user device.

In some aspects, the techniques described herein relate to a system, wherein movements by the user as recorded by the image capture device are combined with the virtual venue as background and transmitted via the pixel stream for display to the user in real time.

In some aspects, the techniques described herein relate to a system, wherein the video stream of the user from the image capture device is captured while the image capture device is not touching the user.

In some aspects, the techniques described herein relate to a system, wherein to generate the pixel stream, the pixel streaming subsystem is further configured to modify a visual image of the user in the video stream.

In some aspects, the techniques described herein relate to a method including: receiving, from a first user device, a request to begin video streaming; responsive to the request, identifying a user and an access right of the user to access a virtual venue from among a plurality of virtual venues; establishing a first URL for video streaming the user and a second URL for pixel streaming video of the user in the virtual venue; receiving, via the first URL, a video stream of the user from an image capture device; removing, from the video stream, background elements based on image recognition; encoding the video stream via a video codec and packaging the encoded video stream into a video stream container; combining video of the user with the virtual venue based on the video stream container and a background virtual environment that represents the virtual venue; generating a pixel stream based on the combined video and the virtual venue; and transmitting the pixel stream to the first user device or a second user device via the second URL established by a microservices subsystem.

In some aspects, the techniques described herein relate to a method, further including replacing background elements of the video stream with a chroma key; wherein to combine the video of the user with the virtual venue, the method further includes replacing the chroma key with the background virtual environment.

In some aspects, the techniques described herein relate to a method, wherein to generate the pixel stream, the method further includes combining video of other users with the virtual venue and displaying the other users next to the combined video of the user in the virtual venue.

In some aspects, the techniques described herein relate to a method, further including placing the combined video of the user into privileged access areas in the virtual venue based on a level of the access right of the user.

In some aspects, the techniques described herein relate to a method, wherein the first user device is a mobile device of the user.

In some aspects, the techniques described herein relate to a method, wherein the image capture device is the mobile device of the user.

In some aspects, the techniques described herein relate to a method, wherein to transmit the pixel stream to the user via the second URL established by the microservices subsystem, the method further includes transmitting the pixel stream to a display device of the user that is separate from the first user device.

In some aspects, the techniques described herein relate to a method, further including: combining movements by the user as recorded by the image capture device with the virtual venue as background; and transmitting the movements combined with the virtual venue to a display device of the user in real time.

In some aspects, the techniques described herein relate to a method, wherein the video stream of the user from the image capture device is captured while the image capture device is not touching the user.

In some aspects, the techniques described herein relate to a method, wherein to generate the pixel stream, the method further includes modifying a visual image of the user in the video stream.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor may each be programmed by one or more additional instructions that may perform some or all of the functionality attributed herein to one of the instructions.

The various repositories such as the config. database 142 described herein may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The various components illustrated in the Figures may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The various processing operations and/or data flows depicted in the drawing figures are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A system comprising:
a mobile device comprising:
a user interface configured to: receive a first input from a user to access a virtual venue that includes a display of a video streaming avatar of the user; receive a second input from the user to begin video streaming; and receive a third input from the user to move a video stream of the user within the virtual venue;
an image capture interface configured to, responsive to the second input, capture the video stream of the user and a surrounding background; and
a wireless interface configured to:
transmit the first input to a remote server;
receive a first response from the remote server granting access to the virtual venue;
responsive to being granted access to the virtual venue, receive a first Uniform Resource Locator (URL) from the server to transmit the video stream of the user and the surrounding background;
transmit, to the remote server via the first URL, the video stream of the user and the surrounding background; and transmit to the remote server the third input to cause the virtual venue to change a location of the user within the virtual venue; and
a display device comprising:
at least one interface configured to:
receive a fourth input providing information for accessing the virtual venue;
transmit the information to the server to access the virtual venue;
responsive to the transmitted information, receive authorization to access the virtual venue; receive a second URL from the server; and
receive, from the server via the second URL, a pixel stream comprising at least the video stream of the user without the surrounding background and at least part of the virtual venue; and
wherein the display device is to display the pixel stream while the image capture interface of the mobile device captures a further video stream of the user.

2. The system of claim 1, wherein the surrounding background in the video stream is replaced by at least part of the virtual venue using a chroma key.

3. The system of claim 1, wherein the pixel stream comprises video streaming of other users within the virtual venue, and the display device is further configured to combine the video streaming of the other users with the virtual venue and display the other users next to the video stream of the user in the virtual venue.

4. The system of claim 1, wherein the pixel stream comprises the video stream of the user placed in a privileged access area in the virtual venue based on a level of access right of the user, and the display device is further to display the pixel stream of the user placed in the privileged access area of the virtual venue.

5. The system of claim 1, wherein the video stream of the user is captured while the mobile device is not touching the user.

6. The system of claim 1, wherein the pixel stream further comprises a video stream of a graphically modified version of the user.

7. The system of claim 1, wherein the mobile device is further programmed to facilitate interaction of the user within the virtual venue.

8. The system of claim 7, wherein to facilitate interaction, the mobile device is further programmed to: facilitate interaction with a live show in the virtual venue; facilitate interaction with a live concert in the virtual venue; and a facilitate purchases within the virtual venue.

9. A method comprising:
receiving, by a mobile device, a first input from a user to access a virtual venue including a display of a video streaming avatar of the user;
transmitting the first input to a remote server;
receiving, from the remote server, a response granting access to the virtual venue;
receiving, responsive to the access being granted, a first Uniform Resource Locator (URL) for transmitting a video stream;
receiving a second input to begin video streaming;
capturing, using an image capture interface of the mobile device and responsive to the second input, a video stream of the user and a surrounding background;
transmitting, via the first URL, the video stream of the user and the surrounding background to the remote server;
receiving a third input to move the video stream of the user within the virtual venue;
transmitting the third input to the remote server to cause a change in a location of the user within the virtual venue;
receiving, by a display device, information for accessing the virtual venue;
transmitting the information to the remote server;
receiving authorization to access the virtual venue;
receiving, from the remote server, a second URL;
receiving, via the second URL, a pixel stream comprising at least the video stream of the user without the surrounding background and at least part of the virtual venue; and
displaying, on the display device, the pixel stream while the mobile device captures a further video stream of the user.

10. The method of claim 9, further comprising replacing the surrounding background in the video stream of the user with at least part of the virtual venue using a chroma key technique.

11. The method of claim 9, wherein the pixel stream further comprises video streams of other users within the virtual venue, the method further comprising combining the video streams of the other users with the virtual venue and displaying the other users adjacent to the video stream of the user.

12. The method of claim 9, further comprising placing the video stream of the user in a privileged access area of the virtual venue based on a level of access right associated with the user and displaying the user in the privileged access area.

13. The method of claim 9, wherein capturing the video stream of the user is performed while the mobile device is not touching the user.

14. The method of claim 9, wherein the pixel stream further comprises a video stream of a graphically modified version of the user.

15. The method of claim 9, further comprising facilitating interaction of the user within the virtual venue using the mobile device.

16. The method of claim 15, wherein facilitating interaction comprises at least one of:
facilitating interaction with a live show in the virtual venue;
facilitating interaction with a live concert in the virtual venue; and
facilitating purchases within the virtual venue.

17. A non-transitory computer-readable medium storing instructions that, when executed by one or more processors, cause a system to:
receive a first input from a user to access a virtual venue including a display of a video streaming avatar of the user;
transmit the first input to a remote server;
receive a response granting access to the virtual venue;
receive, responsive to the access being granted, a first Uniform Resource Locator (URL) for transmitting a video stream;
receive a second input to begin video streaming;
capture a video stream of the user and a surrounding background;
transmit, via the first URL, the video stream of the user and the surrounding background to the remote server;
receive a third input to move the video stream of the user within the virtual venue;
transmit the third input to cause a change in a location of the user within the virtual venue;
receive information for accessing the virtual venue from a display device;
transmit the information to the remote server;
receive authorization to access the virtual venue;
receive a second URL from the remote server;
receive, via the second URL, a pixel stream comprising at least the video stream of the user without the surrounding background and at least part of the virtual venue; and
display the pixel stream while a further video stream of the user is captured.

18. The non-transitory computer-readable medium of claim 17, wherein the instructions further cause replacement of the surrounding background in the video stream of the user with at least part of the virtual venue using a chroma key.

19. The non-transitory computer-readable medium of claim 17, wherein the pixel stream further comprises video streams of other users within the virtual venue, and the instructions further cause combining the video streams of the other users with the virtual venue and displaying the other users adjacent to the video stream of the user.

20. The non-transitory computer-readable medium of claim 17, wherein the instructions further cause facilitating interaction of the user within the virtual venue, the interaction comprising at least one of:
interaction with a live show;
interaction with a live concert; and
facilitating purchases within the virtual venue.
